(19) United States
(12) Patent Application Publication
(10) Pub. No.: US 2007/0260014 A1
(43) Pub. Date: Nov. 8, 2007

(54) Cross-linkable base layer for interlinings applied in a double-dot method

(75) Inventors: Ulrich Simon, Herne (DE); Andreas Pawlik, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/575,104

(22) PCT Filed: Aug. 16, 2004
(86) PCT No.: PCT/EP04/51806

§ 371 Date: Apr. 10, 2006

(30) Foreign Application Priority Data
Oct. 9, 2003 (DE) 103 47 665.2

(51) Int. Cl. C08L 67/02; C08G 63/02; C08G 69/08

(52) U.S. Cl. 525/165; 528/310; 528/272

(57) ABSTRACT

Interlining with a double dot for the coating and/or lamination of sheetlike structures, wherein upper dot is based on an amine-terminated, crosslinkable copolyamide and the lower dot is of an OH-terminated copolyester and further comprises a crosslinker and an acrylic and/or PU dispersion.

The invention relates to a crosslinkable hotmelt adhesive coating based on a powder mixture comprising a commercially customary, OH-group-terminated copolyester based on terephthalic acid, isophthalic acid and butanediol or butanediol in combination with small amounts of up to 12 mol %, preferably from 6 to 10 mol %, of other diols such as hexanediol or polyethylene glycol or PTHF, having melting points of from 100 to 150° C., and a pulverized free or blocked isocyanate, an aqueous epichlorohydrin or a liquid or solid epoxide, for producing a base dot as a barrier to strikeback in double dot coating. The upper dot consists of an amine-regulated copolyamide, in order to ensure good attachment to the lower dot. The invention relates in particular to a hotmelt adhesive composition for the halftone coating of bondable interlinings for the clothing industry, especially outerwear.

In order to solve the problems regarding the reduced stability to laundering and dry cleaning and regarding the relatively weak adhesion, improved hotmelt adhesive compositions, but also improved coating technologies, have been developed. Duodot or double dot coatings are described, for example, in the patents DE-B 22 14 236, DE-B 22 31 723, DE-B 25 36 911 and DE-B 32 30 579.

The coating supports have been improved by using finer yarns with low-denier individual fibers down to the microfiber range and also synthetic yarns, examples being high-bulk acrylic yarns or polyester yarns. The wovens originally used have largely been replaced by stitch-bonded fabrics, which are a combination of nonwovens and knitted fabrics. These new combinations lead to very soft but also very open constructions which place even greater requirements on the coating methods and hotmelt adhesive compositions, especially with regard to strikeback and strikethrough of the hotmelt adhesive composition.

Costs and quality reasons have led to a marked reduction in the amount of coating applied per m² of interlining material. Whereas formerly the amounts applied were commonly 10-20 g/m², they are nowadays 7-12 g/m². Despite these small amounts, it is necessary to ensure sufficient adhesion and resistance; in other words, the hotmelt adhesive must not strike away into the interlining, since then it would no longer be available for the actual bonding.

The object on which the invention was based, therefore, was to find an effective strikeback barrier which with a reduced amount of coating features high bond strength, effective attachment of the upper dot to the base layer and high stability to laundering and dry cleaning.

A range of strikeback barriers are known: crosslinking acrylate dispersions or polyurethane dispersions, or powder-filled pastes based on high-melting acid-regulated copolyamides and polyethylene or on high-viscosity thermoplastic polyurethane powders.

All systems have more or less severe disadvantages in terms of application, attachment to the upper dot or stability to laundering. In addition, the dispersions cannot be employed on coarse, hairy interlinings.

When self-crosslinking acrylate or polyurethane dispersions are coated, there is partial crosslinking even in the course of coating, which leads to a deposit on the stencils and thus to clogging of the stencil holes. Laborious cleaning of the unit is required. Great difficulties are experienced when there is production-induced standstill. A further problem is the attachment of the upper dot to the base layer. The high-viscosity powder-filled systems based on acid-regulated polyamide, polyethylene and polyurethane do not achieve the required strikeback security.

In DE-198 08 809 a description is given of how a free isocyanate is stabilized to water: the free isocyanate is incorporated by extrusion into an inert polyethylene matrix and subsequently finely ground again. By this means success was achieved in creating a stable crosslinkable system for the base dot. The disadvantage of this system is the complicated and hence expensive preparation of the water-stable isocyanate; additionally, the polyethylene matrix hinders the diffusion rate, which signifies a reduction in the reaction rate.

In a preferred embodiment a commercially customary copolyester with OH end groups is mixed with a passivated trimerized diisocyanate (as described in DE 35 17 333 A1) and the mixture is processed as an aqueous paste by rotary screen printing.

It has now surprisingly become possible to prepare a very reactive system in accordance with the claims, having an activation temperature in the range from about 100 to 130° C. and having water resistance. The crosslinkable hotmelt adhesive composition according to the invention for the coating and/or lamination of sheetlike structures has the feature that the reactive components present in the hotmelt adhesive composition do not react, with crosslinking, until in the melt.

Polyisocyanates, particularly solid polyisocyanates, are dispersed with isocyanate-reactive media, such as diamines (hexamethylenediamine), and by that means are surface-stabilized with respect to the surrounding medium. This deactivation is brought about by treating the isocyanate particles on the surface with a deactivating agent in amounts which are stoichiometric with respect to the total isocyanate content. The passivated fraction is in the range from 0.01 to 10%, preferably from 0.1 to 5%.

It is also possible, however, to use other crosslinkers, such as aqueous epichlorohydrin or epoxides. In the course of subsequent drying in the oven at about 100 to 130° C., crosslinking is initiated within a few seconds to give a crosslinked strikeback barrier for the double dot. In this way it is possible to avoid the customary problems of isocyanate-containing systems, which are for example that capped isocyanates (with caprolactam or oximes as capping agent or obtained by dimerization) require excessive activation temperatures; furthermore, no extraneous substances should be released in the course of bonding. The other problem was that non-blocked isocyanates react with water while still in the paste.

Suitable isocyanates are solid isocyanates containing more than 2 free NCO groups and having a melting range of from 100 to 130° C. (e.g. Vestanat T 1890 from Degussa AG). The fraction of the polyisocyanate relative to the polyester used is in the range from 3 to 20% by weight, preferably from 5 to 10% by weight.

Also suitable as crosslinking component are epoxides having a melting range of from 90 to 130° C., preferably from 100 to 120° C., a molecular weight range of from 2 000 to 6 000, preferably 2 500 to 3 000, and more than 2 epoxide groups per molecule; bisphenol A may be mentioned as an example.

A surprising finding was particularly effective attachment of the lower dot to the upper dot material employed. The amine-regulated copolyamide, as upper dot material, reacted with the reactive components of the lower dot paste and formed an optimum attachment at the boundary of the two dots, which is not possible with normal, acid-regulated polyamides. Suitable products for the base dot and upper dot are low-melting grades of low viscosity. The melting point should be between 90 and 150° C., preferably between 115 and 130° C., with a solution viscosity eta rel in the range from 1.2 to 1.7, preferably from 1.25 to 1.5. By this means, the boundary layer reacts with the crosslinker-containing paste and creates a highly stable bonding of the two dots. The coating amounts for the base dot should be from 1.5 to 5 g/m², preferably from 2 to 4 g/m², and for the upper dot, depending on application, should be from 4 to 8 g/m², especially from 5 to 7 g/m². The base dot can be applied as a paste in a halftone formation. The copolyamides employed are based on dicarboxylic acids with chain lengths of C₆- C₁₅, Cl, LL and diamines (piperazine, hexamethylenediamine, MPD, IPD C₉+C₁₀).

The fraction of the polyester (based on solids content) in the base paste is in the range from 1 to 20% by weight, preferably from 5 to 15% by weight. As acrylate and/or polyurethane dispersions it is possible to employ all common types. Particularly suitable are self-crosslinking butyl acrylates such as PLEXTOL BV 411 from Degussa AG, for example. Polyester:acrylate (PU) ratio based on solids is 1:5-1:20, preferably 1:7-1:15.

### EXAMPLES

A powder mixture comprising an OH-terminated copolyester (VESTAMELT 4680-P1) and a trimerized polyisocyanate from Degussa (VESTAGON T 1890) was dispersed with a diamine (e.g. hexamethylenediamine) and a common dispersant in water and the dispersion was passivated (diamine in an equimolar deficit relative to NCO groups, 1:50). A common acrylate dispersion, e.g. PLEXTOL BV 441, and a thickener, e.g. Mirox TX, from Stockhausen, were processed to a printable paste, as described in DE-B 20 07 971, DE-B 22 29 308, DE-B 24 07 505 and DE-B 25 07 504, and the paste was printed with a rotary screen printing unit having a CP 66 stencil onto a 25 g polyester knit comprising high-bulk yarn. The amount applied was 3 g/m². VESTAMELT X 1027-P816 was scattered onto the paste dot while the dot was still wet, the excess was removed by suction, and the material was dried and partially sintered in a drying oven at 130° C. The upper dot (VESTAMELT X 1027-P816) had an add-on of 5 g/m², so that the overall weight was 8 g/m².

### Paste Formulation of the Base Dot

500 g of water
10 g of Mirox TX (polyacrylic acid derivative)
20 g of Intrasol 12/18/5 (ethoxylated fatty alcohol)
400 g of PLEXTOL BV 441
20 g of VESTAMELT 4680-P1
3 g of VESTANAT T 1890
0.15 g of hexamethylenediamine

### Result

A 5 cm wide strip of this interlining was bonded to a siliconized shirt material comprising a polyester/cotton blend at a joining temperature of 127° C. and a linear pressure of 4 N for 10 s, and then the assembly was subjected to laundering at 60° C.

| | |
|---|---|
| Primary adhesion: | 13 N/5 cm |
| 60 [symbol] C. wash: | 10 N/5 cm |
| Back-riveting: | 0.1 N/10 cm |

### Comparative Example 1

### State of the Art

A paste system based on an acid-regulated polyamide and on a polyethylene was applied to the same interlining and the material was scattered with the same upper dot material (VESTAMELT X 1027-P816), dried and sintered. The same amounts of base dot and upper dot were applied.

### Paste Formulation

1500 g of water
35 g of Mirox TX
40 g of Intrasol 12/18/5
400 g of Schättifix 1820 (LP polyethylene)
200 g of VESTAMELT 250-P1

Schättifix 1820 is a low-pressure polyethylene having a melting point of 128-130° C. and an MFR of 20 g/10 min.

### Result

| | |
|---|---|
| Primary adhesion: | 9 N/5 cm |
| 60° C. wash: | 5 N/5 cm |
| Back-riveting: | 0.9 N/10 cm |

### Comparative Example 2

A paste system based on an acid-regulated polyamide and on an acrylate dispersion was applied to the same interlining and the material was scattered with the same upper dot material (VESTAMELT X 1027-P816), dried and sintered. The same amounts of base dot and upper dot were applied.

### Paste Formulation

500 g of water
10 g of Mirox TX
20 g of Intrasol 12/18/5

400 g of PLEXTOL BF 440

| | |
|---|---|
| Primary adhesion: | 6 N/5 cm |
| 60° C. wash: | 3 N/5 cm |
| Back-riveting: | 1.9 N/10 cm |

The advantage of the new technology is that the lower dot is crosslinked even under the drying conditions and, owing to its amine termination, the upper dot is cross-linked with the lower dot during melting, so giving an optimum attachment. Since there is a sharp increase in the molecular weight of the lower dot following coating, it is no longer able to sink into the knit. In the course of subsequent bonding, the low-viscosity polyamide of the upper dot is compelled to flow against the upper material that is to be bonded, since it is unable to flow off downward, hence giving very high adhesions even with very small amounts of hotmelt adhesive. The parting layer between upper dot and base dot, which hitherto has been the weak point of the system, especially in the course of laundering, is more resistant to hydrolytic attack than prior systems and therefore exhibits substantially higher stabilities.

### Products Employed

VESTAMELT 4680-P1 is a copolyester from Degussa AG based on terephthalic acid, isophthalic acid, butanediol and polyglycol, having a melting point of 120° C.

VESTAMELT X 1027-P816 is a ternary copolyamide from Degussa AG with amine end groups 100-400 meq/kg, preferably 250-350 meq/kg, melting point 120° C.

VESTANAT T 1890/100 is a polyisocyanate having a functionality of 3-4, its melting point being at 100-115° C. It is a product of Degussa AG.

PLEXTOL BV 411

PLEXTOL BV 411 is an aqueous dispersion of a self-crosslinking acrylic polymer.

1. A hotmelt adhesive composition for the coating, lamination, or coating and lamination of a sheetlike structure in accordance with the double dot technique, wherein upper dot comprises an amine-terminated crosslinkable copolyamide and the lower dot comprises an OH-terminated polyester and further comprises a crosslinker and an acrylic dispersion, a polyurethane dispersion, or an acrylic and polyurethane dispersion.

2. The hotmelt adhesive composition of claim 1, wherein the upper dot an amine-regulated copolyamide.

3. The hotmelt adhesive composition of claim 1, wherein the upper dot is an amine-regulated copolyamide powder having a melting range of from 90 to 150° C. and a solution viscosity eta rel in the range from 1.2 to 1.7.

4. The hotmelt adhesive composition of claim 1, wherein in the lower dot, the OH-terminated polyester is an OH-terminated copolyester.

5. The hotmelt adhesive composition of claim 1, wherein the lower dot comprises an acrylic dispersion.

6. The hotmelt adhesive composition of claim 1, wherein the crosslinker is a solid isocyanate which comprises more than two reactive isocyanate groups per molecule.

7. The hotmelt adhesive composition of claim 6, wherein the solid isocyanate has a melting range of from 100 to 130° C.

8. The hotmelt adhesive composition of claim 1, wherein an epoxide having a melting range of from 90 to 130° C., a molecular weight range of from 2,000 to 6,000 and more than two epoxide groups per molecule is employed as the crosslinker.

9. The hotmelt adhesive composition of claim 1, wherein the crosslinker is a pulverulent free or blocked isocyanate.

10. The hotmelt adhesive composition of claim 1, wherein the crosslinker is an epichlorohydrin.

11. The hotmelt adhesive composition of claim 4, wherein the OH-terminated copolyester is reactive, and is employed, as part of the lower dot, as a strikethrough barrier.

12. The hotmelt adhesive composition of claim 4, wherein the lower dot further comprises a passivated isocyanate and wherein the lower dot is applied in halftone formation as a paste.

13. (canceled)

14. The hotmelt adhesive composition of claim 1, wherein the copolyester comprises, in polymerized form, monomeric units selected from the group consisting of terephthalic acid, isophthalic acid, adipic acid dodecanedioic acid, butanediol, hexanediol, polyglycol, PTHF, and combinations thereof.

15. A method of coating or laminating sheetlike structures comprising coating or laminating the sheetlike structures with the hotmelt adhesive composition of claim 1.

16. An interlining material for clothing, comprising a material and a coating or a lamination, wherein the material is coated or laminated, and wherein coating or lamination comprises the hotmelt adhesive composition of claim 1.

17. The hotmelt composition of claim 1, wherein the lower dot comprises a polyurethane solution.

18. The hotmelt composition of claim 1, wherein the lower dot comprises an acrylic and polyurethane dispersion.

19. The hotmelt adhesive composition of claim 9, wherein the crosslinker is a pulverulent free isocyanate.

20. The hotmelt adhesive composition of claim 9, wherein the crosslinker is a blocked isocyanate.

21. The method of claim 15, wherein when the sheetlike structures are coated or laminated, the crosslinker is crosslinked and wherein the crosslinking is accelerated by catalysis.
